(19) United States
(12) Patent Application Publication
(10) Pub. No.: US 2010/0054218 A1
(43) Pub. Date: Mar. 4, 2010

(54) Method and System for Detecting Broadcast Receivers and Transitioning to Selective Communications

(76) Inventors: Richard Mark Clayton, Manorville, NY (US); Thomas Bianculli, Manorville, NY (US); Patrick M. Brown, Holbrook, NY (US); Leo Greeley, Shoreham, NY (US); Amrit Natt, Gilbert, AZ (US); Naveen Raj Venugopal, San Jose, CA (US)

Correspondence Address: MOTOROLA, INC., 1303 EAST ALGONQUIN ROAD, IL01/3RD, SCHAUMBURG, IL, 60196, US

(21) Appl. No.: 12/199,565

(22) Filed: Aug. 27, 2008

(51) Int. Cl. H04Q 7/24

(52) U.S. Cl. 370/338

(57) ABSTRACT

A method and a device for detecting the presence of broadcast receivers, such as mobile communication devices, within a communication network and transitioning to selective communications to one or more of the receivers. The method including sending a broadcast query to a plurality of mobile units (“MUs”), receiving at least one response from each at least one of the MUs, each of the responses specifying whether each of the at least one MU that can receive a broadcast transmission, and indicating to a user whether any of the MUs responded to the broadcast query. Described is a further method including receiving a broadcast transmission from an MU, sending a request to the MU to conduct a private communication session, and conducting the private communication session with the MU. Described is a device including means for determining whether further devices can receive a broadcast transmission from the device, and means for transitioning from a broadcast communication session to a private communication session.

### FIELD OF INVENTION

The present invention generally relates to systems and methods for detecting the presence of broadcast receivers, such as mobile communication devices, within a communication network and transitioning to selective communications to one or more of the receivers.

### BACKGROUND

Wireless networking has emerged as an inexpensive technology for connecting multiple users with other users within a wireless coverage area of a network as well as providing connections to other external networks, such as the World Wide Web. An exemplary wireless network may be a wireless local area network (“WLAN”) for providing radio communication between several devices using at least one wireless protocol, such as those of the 802.1x standards. A wireless local area network may use radio frequency (“RF”) communication channels to communicate between multiple mobile units (“MUs”) and multiple stationary access points. The access points or access ports (both may be referred to herein as “APs”) of the WLAN may be positioned in various location of the environment to prevent any coverage gaps of the wireless coverage.

As the technology supporting digital Voice over Internet Protocol (“VoIP”), or Internet-based telephony, continues to increase, VoIP communication has become a viable alternative to standard telephone services. Furthermore, there is a demand to combine the use of WLAN technology with VoIP communication to provide wireless VoIP communication. While wireless Internet has expanded to provide data communications between wireless devices, the introduction of wireless VoIP requires seamless transmission of voice communications between wireless Internet devices. Thus, wireless VoIP may provide a user of a VoIP-enabled device, or Mobile Unit (“MU”) such as a VoIP-enabled handset, to make and receive calls over a wireless network while the user is within the range of an Access Point (“AP”) of a WLAN. However, as a user moves from one AP to another, problems may arise in maintaining the integrity of the wireless voice communications within the IP network.

VoIP communication further allows for Internet Protocol “walkie-talkie” communication (i.e., half-duplex communication). Specifically, IP walkie-talkie communication is defined as the use of the Internet Protocol to carry audio information from one announcer to one or more receivers, typically several receivers. Although there is only one announcer at a time (e.g., per channel), the role of announcer and receiver can change over time depending on user input. In addition, multiple independent walkie-talkie voice channels may be implemented. Thus, the walkie-talkie communication protocol would typically use multicast or some type of packet replication approach.

### SUMMARY OF THE INVENTION

The present invention generally relates to methods and devices for detecting the presence of broadcast receivers, such as mobile communication devices, within a communication network and transitioning to selective communications to one or more of the receivers. One method includes sending a broadcast query to a plurality of mobile units (“MUs”), receiving at least one response from each at least one of the MUs, each of the responses specifying whether each of the at least one MU that can receive a broadcast transmission, and indicating to a user whether any of the MUs responded to the broadcast query. A further method includes receiving a broadcast transmission from an MU, sending a request to the MU to conduct a private communication session, and conducting the private communication session with the MU. A device includes means for determining whether further devices can receive a broadcast transmission from the device, and means for transitioning from a broadcast communication session to a private communication session.

### BRIEF DESCRIPTION OF THE DRAWINGS

FIG. 1 shows an exemplary embodiment of an electronic communication device, such as a handheld mobile unit, according to the exemplary embodiments of the present invention.

FIG. 2 shows an exemplary system for detecting the availability of one or more broadcast receivers within a network according to the exemplary embodiments of the present invention.

FIG. 3 shows an exemplary method for detecting broadcast receivers within a network and transitioning to selective communications with one or more of the broadcast receivers according to the exemplary embodiments of the present invention.

FIGS. 4a-4c show an exemplary system for transitioning to selective communications with one or more of the broadcast receivers according to the exemplary embodiments of the present invention.

### DETAILED DESCRIPTION

The exemplary embodiments of the present invention may be further understood with reference to the following description of exemplary embodiments and the related appended drawings, wherein like elements are provided with the same reference numerals. The exemplary embodiments of the present invention are related to systems and methods for detecting the presence of broadcast receivers, such as mobile communication devices or mobile units (“MUs”), within a communication network and transitioning to selective communications to one or more of the receivers. Specifically, the exemplary embodiments of the present invention are related to systems and methods for delivering added user feedback and confidence to gauge how effective a broadcast (e.g., a VoIP walkie-talkie announcement) may be. Furthermore, the exemplary embodiments of the present invention allows for communications over MUs to transition from a broadcast communication to a private conversation (e.g., with one or more members from a broadcast group, such as recipients on a walkie-talkie channel). As described above, VoIP walkie-talkie communication allows for the use of the Internet Protocol for half-duplex communication from one announcer to one or more receivers, typically several receivers. While the role of announcer and receiver can change over time depending on user input, there may be only one broadcasting announcer at a time per channel. Furthermore, it should be noted that multiple independent walkie-talkie voice channels may be implemented. Accordingly, VoIP walkie-talkie communication may use multicast or some type of packet replication approach over these walkie-talkie voice channels.

As will be described in greater detail below, the exemplary embodiments of the present invention allow for a broadcasting MU to receive a request from one or more of recipient MUs to enter into a private communication (e.g., a private channel). In other words, the broadcasting MU may transition from a walkie-talkie broadcast mode (e.g., one-to-many communication) to the walkie-talkie private mode (e.g., one-to-one communication). Thus, the private mode communication allows the user to create a private communication path between one of the broadcast recipient MU and the broadcasting MU.

It should be noted that for the purposes of the exemplary systems and methods described herein, the conversations between a broadcasting MU and a receiving MU (e.g., a recipient MU) may be defined as a communication session. In addition, the terms broadcast and announcement may refer to a one or more-to-all voice communication from one MU directed to each of the other MUs in a group (e.g., on the same walkie-talkie channel). The term multicast may refer to a one-to-many VoIP communication specifying that packet communication may be to multiple receivers. Accordingly, multicasting is a form of broadcasting that may be very efficient where many receivers (e.g., MUs) need to receive the same information. The term unicast may refer to a one-to-one voice communication (or a private mode communication) from one MU directed to a specific individual MU of the group. Furthermore, it should be noted that while the exemplary systems and methods described herein refer to communications utilizing wireless Voice over Internet Protocol (“VoIP”) technology, each of the communication sessions (e.g., broadcasting, multicasting, unicasting, etc.) may be performed according to the present invention regardless of the type of communication protocol used by the exemplary systems and methods. In other words, the exemplary systems and methods are not limited to wireless VoIP communications and thus, may achieve the described functionalities using any communication network including a plurality of communication devices.

In order to standardize the communications over a wireless local area network (“WLAN”), the MUs may be equipped with wireless fidelity (“Wi-Fi”) capabilities, such as compatibility with one or more of the various 802.11x standards (i.e., 802.11a, 802.11b, 802.11g, etc.). The 802.11 standards are a set of Wi-Fi standards established by the Institute of Electrical and Electronics Engineers (“IEEE”) in order to govern systems for wireless networking transmissions.

Those skilled in the art will understand that the term “MU” according to the present invention may also be used to describe any communication device that is capable of receiving and transmitting wireless signals within a network in accordance with the principles and functionality described herein. For example, the MU may be a wearable WiFi communicator utilizing wireless VoIP technology. However, the wearable WiFi communicator is only exemplary, as the MU may be mobile device capable of using a half-duplex mode as a walkie-talkie (i.e., a push-to-talk (“PTT”) mode, a voice activated transmit (“VOX”) mode).

According to the exemplary embodiments of the present invention, an enterprise may deploy a wireless network in order to provide wireless coverage throughout the operating environment of the enterprise. A WLAN offers the enterprise several benefits ranging from cost efficiency to flexibility in installation and scaling. Furthermore, an operating environment having a limited wired infrastructure may easily be converted into a WLAN, offering mobility to compatible wireless devices throughout the environment.

When a user transmits an announcement over a one-to-many communications channel, the user assumes there are other users listening. However in a conventional broadcasting walkie-talkie communication, there is no reverse communication path and the broadcasting user has no way of knowing whether the broadcast had been received by anyone. As will be described in greater detail below, the exemplary embodiments of the systems and methods provides for one-to-many broadcast transmissions over an 802.11 network, wherein the network may behave similar to a conventional walkie-talkie communication network. Specifically, the exemplary systems and methods according to the present invention allow for a user of a communication device, such as a VoIP announcer, to determine whether there are any other devices listening to, or are able to listen to, a multicast voice transmission. Furthermore, the MU may include a button, such as a “go private” button, to allow the user to transition from a group-wide broadcast to a private communication with one or more members of the group. It should be noted that regardless of whether the MU is acting as a broadcasting announcer or as a broadcast recipient, the “go private” button may allow the user of the MU to initiate a private communication, such as a private one-on-one unicast mode, over a VoIP walkie-talkie channel.

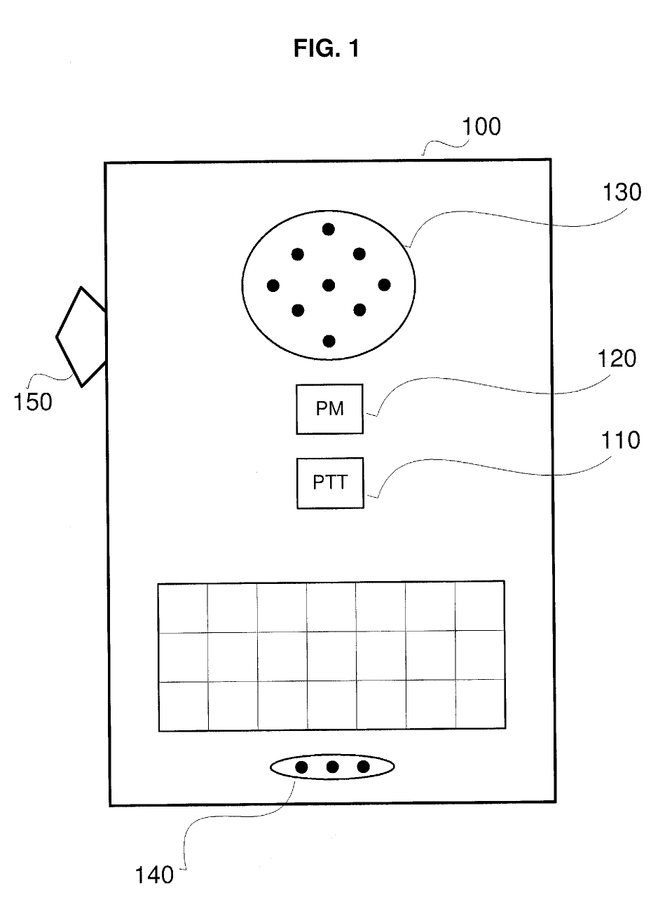

FIG. 1 shows an exemplary embodiment of an electronic communication device, such as a handheld mobile unit (“MU”) 100, according to the present invention. According to the exemplary embodiment, the MU 100 may be a VoIP-enabled handset for communication over an 802.11 network. As shown in FIG. 1, the MU 100 may include a plurality of depressible buttons as an input interface, such as a Push-to-Talk (“PTT”) button 110 and a Private Mode (“PM”) button 120 (e.g., a “Go Private” button). It should be noted that while the exemplary illustration includes a PTT button 110, additional or alternative embodiments of the present invention may utilize VOX technology. Specifically, VOX allows a user to avoid explicitly pressing the PTT button 110 by using voice activation. When the MU 100 detects that the user is talking, the MU 100 may automatically initiate a PTT type activity without user intervention. Accordingly, the communication may still be half-duplex, however it allows for a more natural experience while freeing the user's hands.

It should also be noted that the MU 100 may further include a speaker 130, a microphone 140, and a volume control component, such as a rocker button 150. The rocker button 150 may be a depressible, multi-position switch used for controlling the volume output from the speaker 130. Those skilled in the art would understand that the MU 100 may have several additional components not illustrated in FIG. 1. These additional components may include, but are not limited to, a processor, a memory, a display, a keypad, an antenna, etc.

The exemplary input interface of the MU 100 (e.g., the PTT button 110, the PM button, etc.) may allow for users to control the initiation of a broadcast communication to a group of users, to a subgroup of users, and/or to an individual user. While the exemplary MU 100 is illustrated as having the PTT button 110 and the PM button 120 on the face of the MU 100, these buttons may be located in any position on the housing of the MU 100. It should be noted that each of the buttons on the MU 100 may be configurable by a user of the MU 100. For example, the functions of the PTT button 110 may be assigned to one or more additional buttons, wherein the additional PTT button(s) communicate with a select subgroup within a broadcast group. This subgroup may be, for example, a “Managers Only” PTT button that limits a broadcast to managerial users within the network. Thus, these button may be implemented as software buttons that are displayed, for example, on a touch sensitive display, and may also be user programmable. Furthermore, the configurability of the buttons may reset with an end-user or with an IT department that manages the MU 100.

According to the exemplary embodiments of the present invention, the PM button 120 may provide the user with the ability to transition any conversation from a one-to-all channel to a one-to-one (or a one-to-subgroup) channel. The conventional methods for transitioning a broadcast communication to a private communication include manual selection of a private channel by the users, assigning additional channels to subgroups, and using an alternative wireless communication (i.e., cellular telephones, etc.). However manual transitioning adds complexity to the communication process and may fail if the manually selected channel is already in use. Additionally, the assignment of subgroup channels or the use of cellular telephone would require the recipients to be aware of the specific subgroup channel or telephone number, respectively.

As will be described in greater detail below, the use of the PM button 120 may initiate a private, or limited conversation between an initial broadcasting user and one or more select members of the recipients of the broadcast message. Specifically, the PM button 120 may allow a broadcast recipient MU to transmit a request to a broadcasting MU to enter into a private communication, thereby transitioning the MUs from a broadcast mode to the private mode. Transitioning to PM may limit listener fatigue, as it limits the number of conversations heard by each of the users on the network as well as limiting the ability for a customer to hear private conversations. Using PM may also reduce power drain on each of the MUs within the network, as driving the speaker 130 of the MU 100 may be a significant source of power consumption and with a single channel, all MUs in the network may be outputting audio regards of whether it pertains to each of the users. Furthermore, in a conventional network, there may be limited capacity. In other words, a single channel may become congested, thereby causing a user to wait for a longer time before the channel is clear for communication. The use of a PM channel may eliminate the need for a user to wait for a broadcast channel to clear. Therefore, the exemplary embodiments of the present invention may eliminate the problems associated with transitioning from broadcast to limited, or one-on-one, communication (e.g., unicast communication).

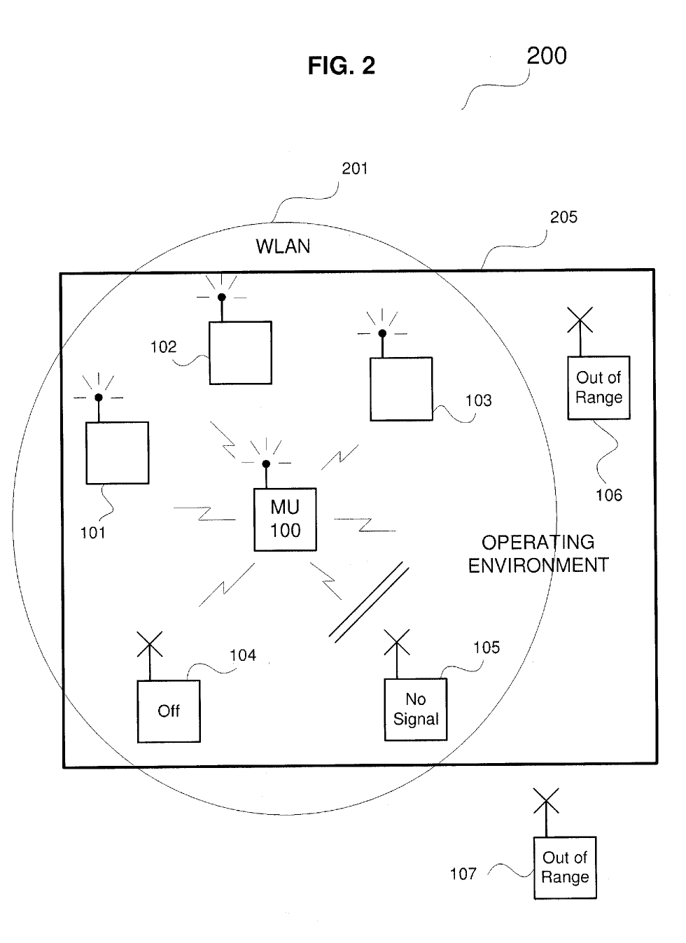

FIG. 2 shows an exemplary system 200 for detecting the availability of one or more broadcast receivers within a network according to the exemplary embodiments of the present invention. The exemplary system 200 may utilize a WLAN architecture 201 to provide continuous wireless coverage throughout an operating environment 205. Thus, the WLAN 201 may be described as a network infrastructure that allows for wireless devices, such as the broadcasting MU 100 and broadcast recipient MUs 101-107. Those skilled in the art will understand that the WLAN architecture 201 illustrated for system 200 is only exemplary and that the principles and applications of the present invention may be applied to any type of wireless network topology.

According to exemplary embodiments of the present invention, the operating environment 205 may be within a large establishment, or operating environment, such as, for example, a business office, a department store, a mall, a warehouse, a package handing facility, a storage lot, a home, a school, a campus, etc. The operating environment 205 may maintain the WLAN 201 in order to provide continuous wireless coverage throughout multiple areas of the establishment. MUs 100-107 may thus be deployed within this coverage to initiate communication with an AP (not shown) of the WLAN 201. As described above, the WLAN 201 may utilize at least one wireless protocol, such as any of the protocols of the 802.1x standards. Advantageously, the WLAN 201 may be set up within an establishment in an unobtrusive and inexpensive manner. Furthermore, the elimination of wires allows for the components of the WLAN 201 infrastructure to be placed in various locations and easily repositioned throughout the operating environment 205.

Each of the MUs 100-107 may include an antenna for communicating with the AP, as well as other MUs. In addition, each of the MUs 100-107 may include a unique identification, such as, for example, an Internet Protocol (“IP”) address or a Medium Access Control (“MAC”) address. Furthermore, one of the MUs, e.g., 100, may be designated the broadcasting MU 100. The broadcasting MU 100 may be in communication with each remaining MUs 101-107 of the network. Thus, the broadcasting MU 100 may transmit and receive data with each of the other MUs 101-107 via a wireless connection. It should be noted that while FIG. 2 illustrates MU 100 as the broadcasting MU, those skilled in the art would understand that any of the other MU 101-107, as well as a plurality of MUs may act as the broadcasting MU. However, there may only be one broadcasting MU for each walkie-talkie channel at a time. Regardless of the usage of the PM feature, no new behavior or capabilities is required by any of the MUs 100-107.

As described above, the system 200 allows for the MU 100 to provide a user with one-to-many (e.g., walkie-talkie) communication feature while delivering user feedback and confidence in order to gauge the effectiveness and success of a one-to-all voice transmission (e.g., a broadcast, an announcement, etc.) or a one-to-many voice transmission (e.g., a multicast, etc.) from the MU 100 to the other MUs 101-107. In other words, the system 200 allows the user to determine whether an announcement will be effective and to choose an alternative course of action if needed.

According to the exemplary embodiments of the present invention, the broadcasting MU 100 may utilize additional IP communications between the other MUs 101-107 to determine whether any of these devices are listening to, or are able to listen to an 802.11 multicast voice transmission from MU 100. The detection may occur at the beginning of an announcement as a simple “go” or “no-go” signal verification. Specifically, this may be performed with an independent multicast query (or broadcast query) that may only be answered by MUs that would be available to hear the announcement being considered. In other words, the user of the broadcasting MU 100 may not get the “go” signal to make the announcement until at least one of the other MUs 101-107 has responded. As will be described in greater detail below, this approach may be extended to display a device count or a list of MUs that are listening (i.e., available to receive the announcement). Furthermore, this displayed list of MUs may be updated in real-time or at periodic intervals.

According to an alternative embodiment of the exemplary system 200, the same behavior may be provided in an environment wherein walkie-talkie functionality is implemented via packet or call replication. Packet replication refers to an alternative to multicast, wherein which many unicast packet communication streams may be used to communicate the same information to many receivers. Typically the replication may be performed at a server, but it may also occur in a device, such as MU, if the number of recipients is not too large. Furthermore, in call replication, each of the listener, such as recipient MUs, may be managed with a separate communication stream, thus, this manager already knows the number of listeners there are.

As illustrated in FIG. 2, the plurality of MUs 100-107 may be located in various positions throughout the system 200 and may be in a variety of operating conditions (e.g., on, off, low signal, no signal, etc.). Specifically, MUs 100-105 may be located within the coverage area of the WLAN 201 and within the operating environment 205. However, the MU 104 may be in an “off” condition and the MU 105 may be in a “no signal” condition (e.g., the MU 105 may be shielded, or otherwise obstructed, from communication over the WLAN 201). The MU 106 may within the operating environment 205, but out of range from the WLAN 201. The MU 107 may be outside both the operating environment 205 and outside the coverage of the WLAN 201.

As described above, the broadcast MU 100 may transmit a multicasting query within the WLAN 201 prior to transmitting an announcement. This query will allow the user of the MU 100 to determine which of the other MUs 101-107 are available to receive the announcement. According to the locations and conditions depicted in FIG. 2, MUs 101-103 may receive the query and, in response, may transmit an acknowledgement signal back to the MU 100. However, the MU 100 may not receive an acknowledgement signal from MU 104 (turned off) or MU 105 (no signal) based on the operating conditions of these MUs. Furthermore, the MU 100 also may not receive an acknowledgement signal from MU 106 (outside the WLAN 210) or MU 107 (outside the operating environment) based on the locations of these MUs. Furthermore, if one of the MUs 101-107 is performing another task, (e.g., “do-not-disturb” task, such as a telephone call, a high-priority walkie-talkie channel operation, an important business application, etc.) the MU may not send an acknowledgement since the user operating the MU may not hear the initial walkie-talkie announcement from MU 100. It should be noted that the receiving MU may be able to receive the VoIP data, however a user interface design limitation may prevent this walkie-talkie announcement from being played to the user.

Once the acknowledgement signals from each of the available MUs (e.g., MU 101-103) has been received by the broadcasting MU 100, the user may be notified of their availability. For instance, the display of the MU 100 may list each of the MUs 101-107 deployed throughout the operating environment. Accordingly, each MU may be displayed on the MU 100 with its respective status (e.g., “MU 101: available”; “MU 104: unavailable”; etc.). If none of the MUs 101-107 are listed as available, or if an intended recipient is not listed as available, the user of the broadcast MU 100 may choose not to transmit the broadcast announcement and find an alternative method for communication with the intended recipients.

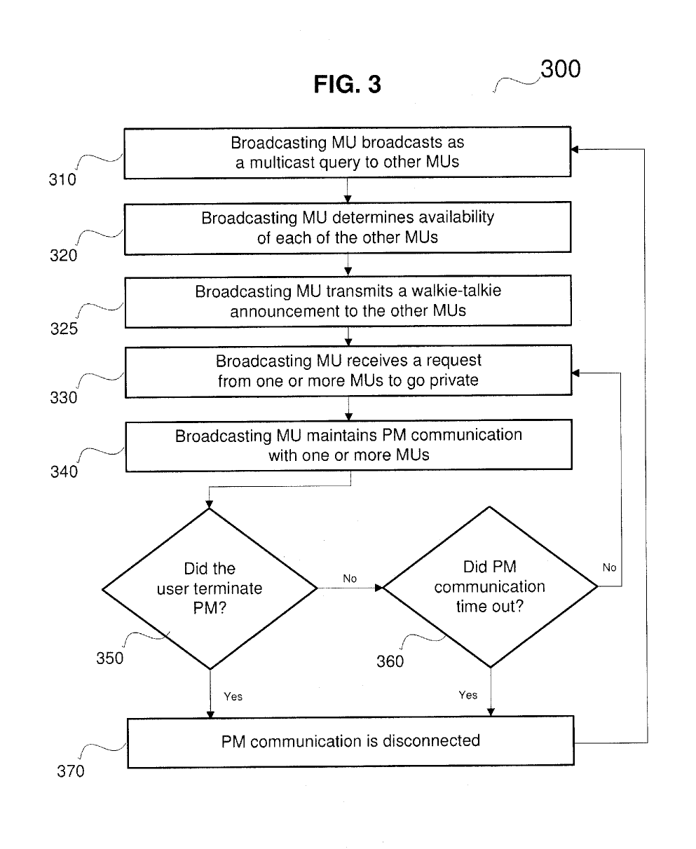

FIG. 3 shows an exemplary method 300 for detecting one or more broadcast receivers within a network (e.g., the WLAN 201) and transitioning to selective communications with one or more of the broadcast receivers according to the exemplary embodiments of the present invention. The exemplary method 300 will be described with references to the exemplary MU 100 and system 200 of FIG. 1 and 2, respectively.

As described above, the exemplary MUs 100-107 may include Voice over Internet Protocol (“VoIP”) telephone functionality. Specifically, the MUs 100-107 may be mobile handheld communication devices. According to the present invention, the method 300 may allow for a user of the broadcasting MU 100 to determine the availability of the other MUs 101-107 and may also allow the user of the MU 100 to transition from a broadcast mode to private communication mode with one or more of the recipient MUs 101-107. As described above, the WLAN 201 may be implemented within a business enterprise and an AP of the WLAN 201 may provide requesting MUs 100-107 within the enterprise with VoIP data support.

In step 310, the MU 100 may broadcast a multicast query to each of the other MUs 101-107 within the operating environment 205. Specifically, this multicast may specify a walkie-talkie channel that is being probed. It should be noted that the probing multicast may part of a walkie-talkie protocol or an independent protocol. As described above, the multicast query may allow the MU 100 to perform a simple “go” or “no-go” signal verification. For example, the “go” signal may be indication that at least one or more of the recipient MUs 101-107 has acknowledged the multicast query and thus, is available to receive a broadcast or announcement from the MU 100. Conversely, a “no-go” signal may be an indication that none of the other MUs 101-107 have acknowledged the multicast query and thus, there are no available recipients for the broadcast or announcement from the MU 100. According to one embodiment of the present invention, the MU 100 may be continuously probing a channel for the number of available listeners.

Accordingly, in step 320 the MU 100 may determine the availability of each of the MUs 101-107 based on any received acknowledgement signals from one or more of the MUs 101-107 in the WLAN 201. Specifically, at least some of the MUs 101-107 that are listening, or otherwise available (e.g., not in do-not-disturb mode), may respond via unicast back to the probing MU 100. As described above, a list of any available MUs may be displayed on the MU 100 to inform the user of the number of MUs that are able to listen to the broadcast. By counting the responses, the user of the MU 100 may know how many listeners there are. For example, as illustrated in FIG. 2, the MUs 101-103 may be able to listen to a broadcast from the MU 100 while the other MUs 104-107 may be unable to listen to the broadcast (e.g., the MU may be out of range, turned off, have no signal, etc.). Therefore, a list may be provided to the user indicating that MUs 101-103 are available while MUs 104-107 are unavailable. This feedback may provide the user with added confidence for gauging how effective the broadcast may be. It should be noted that if none of the MUs 101-107 acknowledge receipt of the multicast query, the method 300 may return to step 310 wherein the MU 100 may initiate a new broadcast to all. According to one embodiment of the present invention, the recipient MUs 101-107 may transmit an unconditional response regardless of whether an announcement from the MU 100 on a specified channel would be heard. This unconditional response may include an indication as to whether the announcement would be heard, and a summary of this information may be provided to the user of the MU 100.

According to the exemplary embodiments of the present invention, the detection of number of listeners (e.g., the availability of the MUs 101-107) described in method 300 and the transition from a broadcast communication to a private communication are separate features that do not depend on each other. Thus, these steps 310 and 320 described above may be optional steps from the prospective of the private mode transitioning features.

In step 325, the MU 100 may transmit a walkie-talkie announcement (e.g., a one-to-many communication) to the MUs 101-107. According to one embodiment of the present invention, the announcement may be electronically annotated to control the type of response permitted. For example, the announcement may force all responses to the broadcast to be private or may prevent any private responses. However, according the exemplary method 300, the announcement may allow the responder to choose a private (one-on-one) communication or a walkie-talkie (one-to-many) communication. It should be noted that this annotation may be driven by the user actions at the broadcasting MU 100 or may be fixed as a configuration or device behavior.

In step 330, the MU 100 may receive a request from one of the MUs 101-107 to enter into private mode (“PM”) communications. Specifically, the MU 100 may transition from a broadcast mode (e.g., one-to-many communication) to the PM mode (e.g., one-to-one or one-to-subgroup). As described above, each of the MUs 100-107 may include a PTT button 110 and a PM button 120. The PTT button 110 allows the user to reply to a broadcast using a one-to-many communication channel (e.g., the same or similar to the channel used by the broadcasting MU 100 during an announcement or broadcast). The PM button 120 allows the user to create a private communication path between the user (i.e., broadcast recipient) and the previous one-to-many user (i.e., broadcasting user). The transition from a broadcasting mode to the PM mode may be indicated to the users of the MUs 100-107 via an audible or visual cue. For example, a distinctive chime over the speaker (e.g., “ding”, “beep-beep”, etc.) and/or a PM icon on the display (e.g., “PM”, “Private”, etc.) may be activated once a broadcast recipient creates a private communication path with the broadcasting user.

According to an additional or an alternative embodiment of the present invention, the responding MU may automatically be placed into a private conversation with the broadcasting MU 100. As described above, this may depend on the annotation of the announcement. For example, the broadcasting MU 100 may broadcast an announcement to all available MUs 101-103. When MU 101, for instance, responds to the broadcast, the MU 101 may be placed into PM communication with MU 100. In other words, the initial communication from the MU 100 may be on a one-to-all channel, but whichever MU replies (e.g., MU 101) would automatically be transitioned into a private session with MU 100. Furthermore, the broadcasting MU may determine that the initial broadcast may be on a one-to-all channel and the responding MU 101 may be automatically transitioned to a private one-to-one channel.

In step 340, the MU 100 may maintain PM communications with one of the other MUs 101-107. Specifically, the private communication channel may appear to the users as a private walkie-talkie channel and retain the half-duplex communication behavior. Thus, once this private communication (e.g., PM communication) is created, the two users may continue to converse while no other users hear the conversation. As will be described below, a private communication session may be closed by being “timed out” and/or by explicit termination by a user.

In step 350, a determination may be made as to whether the user of the MU 100 intends to return to broadcast mode. For example, a user of any of the MUs 100-107 may terminate the private communication session by pressing the PTT button 110. Similar to when entering a PM communication, a visual or audible cue may be activated when the MU 100 exits a PM communication. Accordingly, the PTT button 110 may resume one-to-all broadcasting mode. It should be noted that alternative methods may be available to the user for exiting PM communication, such as selecting of an item displayed on the MU 100. Thus, if the MU 100 receives explicit instructions (e.g., depressing the PTT button 110) to return to broadcast mode, such as one of the users (e.g., the broadcasting user or the listening user) depresses the PTT button 110, the method 300 may advance to step 370 where the MU 100 is returned to broadcast mode. If the MU 100 does not receive instructions to return to broadcast mode, the method 300 may advance to step 360.

In step 360, it may be determined whether a PM communication has timed out. Specifically, a timer within the MU 100 (or any of the MUs 101-107) may start during a period of user inactivity. A duration of time may be predetermined wherein the MU 100 is timed out and PM operations is terminated (e.g., following an expiration of a timer). Thus, if it is determined that the MU 100 has timed out due to user inactivity, the method 300 may advance to step 370 where the PM communication is disconnected. According to one embodiment, the MU 100 may be configured to return to broadcast mode, wherein the MU 100 is eligible to transmit or receive walkie-talkie announcement. Thus, in broadcast mode, the user may initiate a new one-to-many broadcast (e.g., one-to-all communication), wherein the method 300 restarts at step 310. Accordingly, it should be noted that the upon PM disconnection, the behavior of the MU 100 may depend on how the MU 100 is configured, as well as the existence of any high-priority operations.

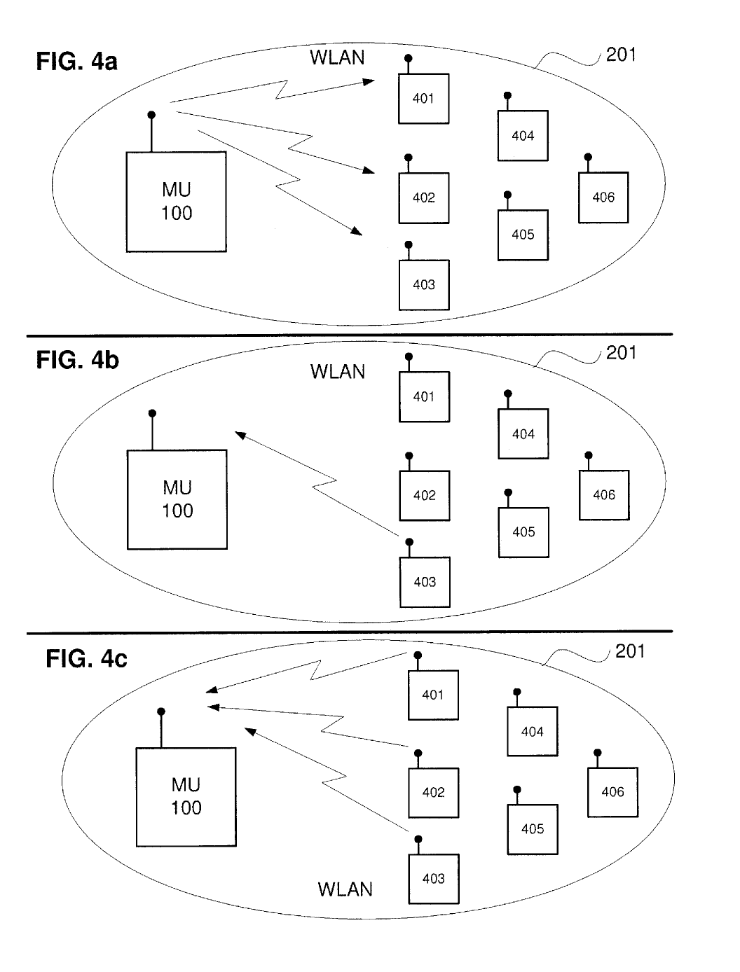

FIG. 4a-4c shows an exemplary system 400 for transitioning to selective communications with one or more of the broadcast receivers according to the exemplary embodiments of the present invention. It should be noted that according to the exemplary FIGS. 4a-4c, each of the receiving MUs 401-406 are available for receiving communication from the MU 100.

FIG. 4a shows the broadcasting MU 100 transmitting an announcement to the group of receiving MUs 401-406. As described above, a multicast query may have been used prior to transmitting the announcement to inform the user of MU 100 that the receiving MUs 401-406 are able to listen to the MU 100. According to one implementation, the announcement may be used to request communication from a specific user, such as a manager. For example, the user of the broadcasting MU 100 may announce that the manager on duty should report in. The multicast query may assure the user of the MU 100 that this announcement was heard by each of the MUs 401-406.

FIG. 4b shows a single MU (e.g., the MU 403) requesting a private communication session with the broadcasting MU 100. According to the exemplary implementation, the single MU 403 may be the manager on duty. Thus, the manager on duty may depress the PM button (or a “go private” button) on the MU 403 to provide the MU 403 with a private communication path with the MU 100. The private communication path could be configured to be one of many forms, such as, for example, a telephone call, walkie-talkie protocol using unicast addresses, dynamically selected walkie-talkie channels, etc. Regardless of the form of the communication path, the benefits and functionalities described herein for the exemplary system and method will be similar.

FIG. 4c shows a subgroup of MUs (e.g., the MUs 401-403) requesting a private communication session with the broadcasting MU 100. As opposed to having only a single manager on duty, this implementation may allow for a group of users (e.g., managers) to engage in private communication with the broadcasting MU 100. For example, the MU 100 may request that all managers on duty report in. A private communication path may be provided for each of the MUs 401-403 as the respective managers depress the PM button (or a “go private” button) on each of their MUs 401-403. Therefore, a subgroup with the group of MUs 401-406 may be created to allow for private communications amongst members of the subgroup, while preventing the other MUs 404-406 from hearing the conversation.

According to the exemplary embodiments of the present invention, the above-described systems and methods for transitioning from a broadcasting mode to a private mode does not require the use of a server. In addition, the users of the systems and methods do not require the use of a directory of other users and the MUs do not need to have any knowledge of user identity. Furthermore, the systems and methods may operate in any type of IP walkie-talkie approach, such as, for example, multicast or replication). The private mode communication between two users may behave as either half duplex or full duplex. Private communication may appear to the user as a user-answered telephone call, auto-answered telephone call, or a walkie-talkie operation.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
sending a broadcast query to a plurality of mobile units (“MUs”);
receiving at least one response from at least one of the MUs, each of the responses specifying whether each of the at least one MU can receive a broadcast transmission; and
indicating to a user whether any of the MUs responded to the broadcast query.

2. The method according to claim 1, further comprising:
sending the broadcast transmission on one of a plurality of walkie-talkie channels.

3. The method according to claim 1, wherein the indicating is displaying a listing of the MUs that responded.

4. The method according to claim 1, wherein the indicating is allowing the broadcast transmission to be sent.

5. The method according to claim 1, further comprising:
receiving one of a “go” signal when any of the MUs respond and a “no go” signal when none of the MUs respond, the “go” signal and the “no go” signal is at least one of an audio cue and a visual cue.

6. The method according to claim 1, further comprising:
creating a private communication session with at least one of the responding MUs.

7. The method according to claim 1, wherein the sending and receiving are performed within a Voice over Internet Protocol communication network.

8. A method, comprising:
receiving a broadcast transmission from an MU;
sending a request to the MU to conduct a private communication session; and
conducting the private communication session with the MU.

9. The method according to claim 8, wherein the private communication session is a unicast communication session.

10. The method according to claim 8, wherein the private communication session is a multicast communication session.

11. The method according to claim 8, wherein the private communication session is performed within a Voice over Internet Protocol communication network.

12. The method according to claim 8, wherein the private communication session is configured via one of a unicast address over a walkie-talkie protocol, a dynamically selected channel over a walkie-talkie protocol, and a telephone number.

13. The method according to claim 8, further comprising:
receiving an instruction to disconnect from the private communication session, the instruction is one of a user request and an expiration of a timer.

14. The method according to claim 8, wherein sending the request to the MU to conduct a private communication session is performed automatically by a user responding to the broadcast transmission.

15. A device, comprising
means for determining whether further devices can receive a broadcast transmission from the device; and
means for transitioning from a broadcast communication session to a private communication session.

16. The device according to claim 15, further comprising:
a receiving means for receiving a response from each further device that can receive a broadcast transmission.

17. The device according to claim 15, further comprising:
an indicating means for indicating to a user of the device whether any of the further devices responded to the broadcast transmission.

18. The device according to claim 15, further comprising:
a broadcasting means for sending the broadcast transmission.

19. The device according to claim 17, wherein the indicating means is a displayed listing of the further devices that responded.

20. The device according to claim 15, wherein the communication session is performed within a Voice over Internet Protocol communication network.
